(19) United States
(12) Patent Application Publication
(10) Pub. No.: US 2004/0014017 A1
(43) Pub. Date: Jan. 22, 2004

(54) Effective and efficient learning (EEL) system

(76) Inventor: Howard Hou-Hao Lo, Los Angeles, CA (US)

Correspondence Address: Howard H Lo, 3700 Wilshire Blvd., # 720, Los Angeles, CA, 90010, US

(21) Appl. No.: 10/200,331

(22) Filed: Jul. 22, 2002

(51) Int. Cl. G09B 7/00

(52) U.S. Cl. 434/322

(57) ABSTRACT

This invention relates to a system and method for effective and efficient learning (EEL), with interactive, adaptive, and individualized computer-assisted instruction to students, which can be implemented on the Internet, network connected computers, single computer or other devices including designated device. More particularly the system and method includes for each student a student dynamic record adapted to the student which contains the student's personal profile that includes learning style, ability (analysis, understanding, memory, reasoning, deduction, generalizing, applying, and speed), personality, interest, and background knowledge. The student dynamic record reflects its student's behavior in responding to instruction. The EEL system also includes an AI engine consists of a self-improved dynamic rule base, which selects the materials in a knowledge base to control the instructional progress, and guides its student according to educational and psychological theories. The student dynamic record also contains information to direct the AI engine to provide review session. Preferably, a multimedia user interface is included with customizable multimedia presentation personae, which constitute a further aspect of the effective learning experience. The learner-centric education is what intended to achieve.

### 1. FIELD OF THE INVENTION

This invention relates to a system and method for effective and efficient learning (EEL), with interactive, adaptive, and individualized computer-assisted instruction to students, which can be implemented on the Internet, network connected computers, single computer or other devices including designated device. More particularly the system and method is to achieve long-term memory and comprehension by using a learner-centric education model.

### 2. BACKGROUND OF THE INVENTION

Traditional education system ordinarily is in a classroom setting. A classroom typically includes an instructor, a number of students and a selected textbook containing information that the students attempt to learn. The classroom setting not only require students to be presented at the location of the classroom at certain time, which may not be convenient to the students, more importantly it can not be tailored to individual needs of the students. The pace of the class at best can provide the student time to take down notes, no time is available for the students to ponder and absorb the information conveyed in the classroom. Often the students are distracted and obstacles, they cannot adequately copy down information conveyed by the instructors. Moreover, the students'knowledge levels and capabilities in understanding are different; one way of explanation may be helpful to certain students but has no impact on other students.

Meanwhile, one textbook on certain subject is rarely adequate. Often additional materials are needed in order to obtain comprehensive learning. In the classroom setting, the material available to assist the student to understand is limited, and different student may need different kinds of materials and instructional methods to help them to understand. This cannot easily be provided in a classroom setting. The traditional education system cannot provide individualized learning experiences; it is difficult to achieve effective and efficient learning.

In addition, the traditional classroom setting requires teaching staff, space and other commendations that are expensive. At the same time, the students are restricted to follow the fixed schedules and to be in locations that can be inconvenient if not impossible.

More importantly, traditional education methods emphasize instructions, but lack of means to ensure that the student can actually memorize and comprehend the materials. The tradition education method mainly measures the students' levels of learning by tests, but provides no effective and efficient systematic guidance on how to achieve the goal. Individual student needs to figure out what is the effective way to learn the materials the educator required. The common shortcoming is that the student would obtain short-term memories of the materials before the test and not be able to retain long-term memories for most of the materials.

Attempts have been made to improve the traditional system by the applications of computers in education. The previous applications have been limited by several problems, including failure to provide systems that adapt or individualize to each student and failure to actively guide the student in an efficient and effective way. These systems still rely on regular input and supervision by the teachers and administration staffs. These systems still follow the traditional education system's instruction dominant approach.

A number of interactive educational techniques have been implemented on computers; some of these systems lack the ability to recognize and to adapt to each student's individual characteristics entirely. In early work, for example, text-based programmed instruction was converted to computer format and implemented on time-shared systems. This early development was extended with more sophisticated computer-assisted instruction (“CAI”), also known as compute based training (“CBT”). In CAI, for example, the computer acts as a teaching machine. A program presents instructional displays, accepts student responses, edits and judges those responses, branches on the basis of student responses, gives feedback to the student, and records and stores the student's progress.

These CAI systems can not adapt to their students. These systems merely sequence students through educational materials, based only on student performance during a current lesson and using only parameters such as recent responses and pre-requisite patterns. These systems do not gather or use information on more comprehensive student characteristics, such as past student performance, student performance on other courses, student learning styles, and student interests. A greater deficiency is that most existing CAI systems do not recognize characteristics of their individual students. They cannot be individualized or made responsive to their student's styles. For example, U.S. Pat. No. 5,788,508 only provided the capacity to compare the students' answer with the correct answers and to retrieve the material related to questions answered incorrectly.

Other systems provided individualized instructions and interactions in some degree.

U.S. Pat. No. 5,597,312 disclosed a method and system include a computer system for selecting a mode for an adjustable teaching parameter, generating a student model, and monitoring a student interactive task based upon the teaching parameter and the student model. The method and system also include a computer system for generating an updated student model based upon a student response to the student interactive task generated, and monitoring a student interactive task based upon the teaching parameter and the updated student model.

U.S. Pat. No. 6,201,948 utilized the Agent Based Instruction (“ABI”) system for more interactive, adaptive, and individualized computer-assisted instruction and homework. This invention provided agent software (“agent”) and tried to adapt to each student by managing or controlling instruction in a manner approximating a real tutor. The agent exercises management or control over the computer-assisted instruction materials and provides information and help to the student, both synchronously and asynchronously to particular instructional materials. Agent behaviors are sensitive to both the educational context and to the history of student behavior.

U.S. Pat. No. 6,334,779 disclosed a method and system where a learning profile is maintained for every student, which indicates the student's capabilities, preferred learning style, and progress. Based on the profile, an Intelligent Administrator (IA) selects appropriate material for presentation to the student during each learning session. The IA then assesses whether the student has mastered the material. If not, the material is presented in a different way.

The deficiency of these inventions is that they did not provide a system that will guide the students more effectively and achieve high efficiency. These inventions tried to adapt the teaching method and teaching materials to individual student. However, these inventions still emphasize on how to teach the students, not on how to help the student retain the knowledge in an effect and efficient way. These inventions are still limited to imitating the existing education model; they did not utilize the capability of a computer system to guide the student to learn in a more effective and efficient way.

The present invention provides an effective and efficient learning system and method. The purpose of this invention is not only on how to present the information to the student, but also on how to help student understand and memorize the information in an effective and efficient way.

Citation of references hereinabove shall not be construed as an admission that such a reference is prior art to the present invention.

### 3. SUMMARY OF THE INVENTION

This invention relates to a system and method for effective and efficient learning (EEL) with interactive, adaptive, and individualized computer-assisted instruction to students, which can be implemented on the Internet, network connected computers, single computer or other devices including designated device. More particularly the system and method includes for each student a student dynamic record adapted to the student which contains the student's personal profile that includes learning style, ability (analysis, understanding, memory, reasoning, deduction, generalizing, applying, and speed), personality, interest, and background knowledge. The student dynamic record reflects its student's behavior in responding to instruction. The EEL system also includes an AI engine comprises a self-improved dynamic rule base, which selects the materials in a knowledge base to control the instructional progress, and guides its student according to educational and psychological theories. The student dynamic record also contains information to direct the AI engine to provide review session. Preferably, a multimedia user interface is included with customizable multimedia presentation personae, which constitute a further aspect of the effective learning experience. The learner-centric education is what intended to achieve.

The current invention is an effective and efficient learning method and system that can provide motivated dynamic learning experience distinguishable from existing education system with or without computer application.

The advance of the invention is that it not only provides a system and method for interactive, adaptive, and individualized computer-assisted instruction and homework, it also provide a system and method for dynamic learning by the following preferred and alternative embodiments. This invention provides a more effective system responsive to the needs of several parties interested in education.

The present invention is directed to an improved intelligent tutorial utilizing memory and rules that actively guide the student to obtain knowledge and skills. This invention is based on the idea that learning is building up knowledge and skills. Effective learning is to navigate the knowledge base following an efficient route. The first objective of the current invention is to help student to obtain long-term memory of the knowledge in more efficient way. The second objective of the current invention is to help student to better comprehend knowledge and develop useful skills.

These objectives are accomplished by applying rules summarized by researcher in education and related fields and concepts of artificial intelligent. The practical application of these theories intertwines with the development in artificial intelligent and computer technology that provides an effective and efficient learning (EEL) system that will greatly improve the ability of learning.

Another improvement of the current invention over other inventions is that it can eliminate the need of human involvement. Once the knowledge base is established, the AI engine and student dynamic record interactively work with the knowledge base to guide the student through the learning process. The integration of knowledge source and instruction guidance is capable of reducing unnecessary confusion and distraction to the student, which provides efficient and effective learning experience.

In one embodiment of the invention, the knowledge base contains words, the AI engine records the results of each exercise to student dynamic record and refers to the student dynamic records for further instruction.

It is clear to those of skill in the art that by providing interactive, adaptive, and self-paced computer-assisted instruction and homework delivered over widely available computer networks this invention has immediate application in public, private, and commercial school environment of all levels and for trainings and life-long learning. Educational research shows that instruction and homework of these characteristics improves students' educational outcomes. Further, in school contexts this invention advantageously provides immediate access to student performance and pedagogic characteristics to all interested parties, including parents.

### 4. BRIEF DESCRIPTIONS OF THE DRAWINGS

These and other objects, features, and advantages of the invention will become apparent to those of skill in the art in view of the accompanying drawings, detailed description, and appended claims, where:

FIG. 1 illustrates in overview fashion the principal functional components of and parties in the EEL system;

FIG. 2 illustrates in overview fashion an implementation of the functional components of FIG. 1;

FIG. 3 illustrates in more detail the software components and interactions in the implementation of FIG. 2;

FIG. 4 illustrates the exemplary illustration of a preferred embodiment

### 5. DETAILED DESCRIPTION OF THE INVENTION

Section 5.1 presents a general overview of the EEL system. Section 5.2 describes the preferred hardware and operating software configurations. Section 5.3 describes details of the interface between the elements of EEL system.

5.1. EEL System Overview

This invention has particular utility in making education and training available at school, at the office, at home, at schools with geographically dispersed students and to students at geographically dispersed schools, and at other types of locations. Further, it will be apparent that this invention may be most useful for memorizing language, terminology, rules and principals, etc. A designated device contains EEL system maybe used to help student learn a particular area, such as vocabulary or grammar. For example, with voice-control, such device can be carried by the student when walking, running or conducting other activities for language learning.

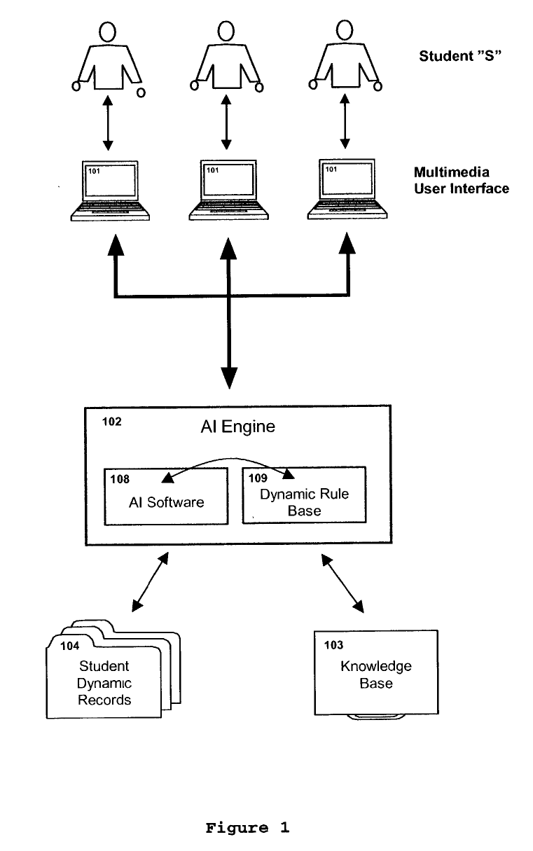

FIG. 1 illustrates the principal actors and the principal functional components in an EEL System. These include, generally, multimedia user interface 101, AI engine 102, knowledge base 103, and student dynamic record 104, the student S interacted with the system through multimedia user interface 101.

The multimedia user interface 101 contains various input and output devices for the student to communicate with the EEL system. This multimedia user interface 101 will then send input from the student to AI engine 102 and receive output from the AI engine 102.

Central to the EEL System is the AI engine 102 formed by the functioning of AI software 108 and dynamic rule base 109, which creates and modifies student dynamic record 104 that stores information about the student S, and retrieves from knowledge base 103 appropriate knowledge and instructions.

Knowledge base 103 presents educational content such as knowledge material, instructional material, and tests for the student S. Instructional materials include computer based instructional materials similar to those known in the art.

The student dynamic record 104 for the most part contains information obtained based on the student's performance and responses to psychological test. It may also contain as a portion of the record general information about the student, such as age, gender, and grade level, etc.

The interaction between student dynamic record 104, knowledge base 103, and multimedia user interface 101 through AI engine 102 is governed by rules established based psychological and educational practice, which will be described as examples in detail below.

When a student S logs on to the EEL system for the first time, the AI engine will first create a student dynamic record 104 for this student. The At engine may make initial inquiries to the student or the operating system in order to obtain initial information. Once the student dynamic record 104 is set up, when the student S logs on to the system, the AI engine 102 will identify the student's identification number, and read respective student dynamic record 104. The AI engine 102 will then select from the dynamic rule base 109 one rule based on the information read from the student dynamic record 104. Then the student is given materials and instructions selected from the knowledge base 103 according to the rule selected from the dynamic rule base 109. Since the information from the student dynamic record 104 reflects the student past performance, the learning materials is selected based on the student performance, instead of by fixed schedule or by the requests from the student. The learning process will be an interactive process. After the student is given the information, the student will be presented with questions in order to test whether the student understands and memorizes the information. The responses from the student will be evaluated by the AI engine 102; the results will be used to revise the student dynamic record 104, and to select another rule from the rule base 108.

In the course of responding to questions presented, the student can ask for advice or hints, the use of a tool such as a calculator, or other relevant assistance. The students may select to control the course of learning on their own; however, the advantage of EEL system is to guide the student with the combination of designed instruction and informational materials, which in effect combines the function of teacher, text book and library and optimize the learning experience like never before.

Once the EEL system is set up, it does not need any interaction between the teacher and the students. The teacher may monitor the student progress through inspecting the student dynamic record 104, however, the EEL system does not require any monitoring once it is in operation.

In the further development, teachers can add additional items to the knowledge base 103, modifying existing items, and alter the dynamic rule base 109 in the AI engine 102. The AI engine 102 may also add new rules to the dynamic rule base 109.

However, the teacher needs not to create different materials or instructions for different student. The interaction of AI engine 102 and student dynamic record 104 will guide each student on his unique pass with relevant knowledge and related instructions.

The materials in knowledge base 103 can be original or can be derived from existing textbooks, or other sources. Information in the knowledge base 103 can be divided into the items that are assigned with entry numbers. The selected rule from dynamic rule base 109 of the AI engine 102 will call on an entry number for each learning session. The rules that link the student's performance with entry numbers are based on the psychology and educational theory. In effect, the sequence of learning is dynamic.

Materials in knowledge base 103 carrying the education content to be presented to a student can include visual display items, such as text, graphics, animation or movies; audible display items, such as voice, audio and so forth. They can include input items known in the computer arts, such as buttons to select, selections, to chose from, text to enter, hypertext and hypermedia links, functions to perform with student input, and so forth.

Further, it is preferable that the on-screen display of EEL system can assume various display personae during student communication. The persona means multiple displays emulate a particular, apparently living, personality. The characteristics of the display persona can be selectable by the student according to the student's preferences; selected by the AI engine 102 based on the student character, or the personae can be specified by the instructional materials.

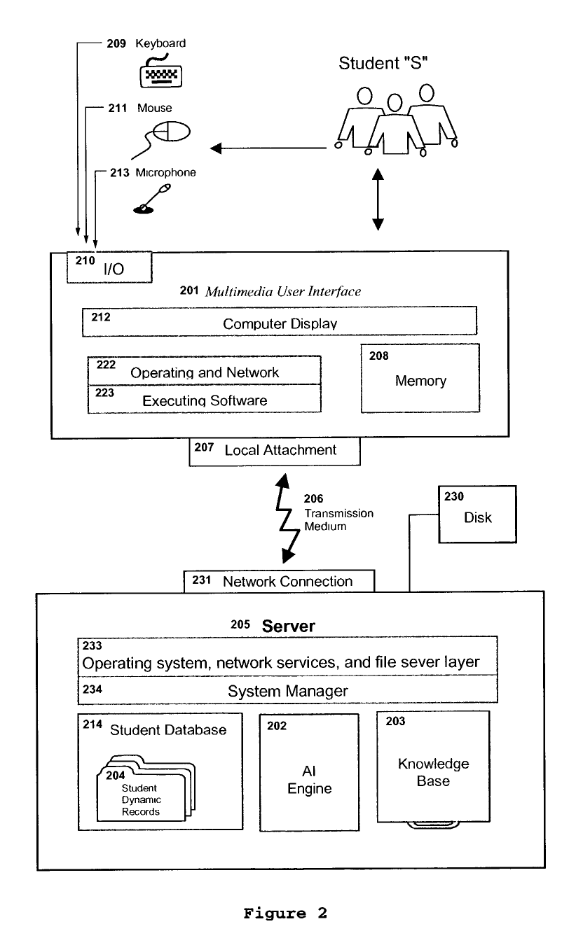

FIG. 2 illustrates an exemplary preferred structure implementing the principal conceptual and functional components of the EEL system as illustrated in FIG. 1. This preferred implementation of the invention is based on Internet or a plurality of computers interconnected by a network. Therefore, an exemplary preferred EEL system includes one or more multimedia user interface 201. The multimedia user interface 201 can be located at school, at home, or at the office. The system further includes one or more servers 205, which consists EEL system software and database.

These multimedia user interfaces 201 and the one or more servers 205 are interconnected by a network that consists of transmission medium 206 and local attachments 207. The network can be a bus-type local area network with collision detection or token passing protocols or both. This invention is adaptable to all forms of networks which support adequate transmission protocols, such as those functionally similar to the TCP/IP protocol suite, and ATM technology to transport voice, data, and video. Networks constructed from switched or non-switched links to a central server, which can be configured of several LAN attached server systems, networks including CATV cable or optical links, networks including radio links either terrestrial or satellite, and public or private packet switching networks can all be used to support the EEL system.

In more detail, multimedia user interface 201 includes memory 208, which may be RAM type real memory or a virtual memory based on RAM type memory and a backing store. When available, a preferable multimedia user interface 201 can be a low cost network computer (“NC”) that has processor, RAM, and network interfaces sufficient to access intranets or the Internet. In a preferred embodiment, the AI engine 202, knowledge base 203, and student dynamic record 204, are all located in a server 205. This permits a student to access the EEL system services from any available multimedia user interface 201 at any time.

The student interacts with the EEL system using any appropriate interactive input/output (“I/O”) modes 210. For input, standard devices include pointing devices, such as mouse 211 or a trackball, keyboard 209, optionally microphone 213 with speech recognition, and so forth. Speech recognition will permit brief conversations with the personae. The invention is adaptable to special input devices appropriate for particular purposes, and to devices yet to be constructed. Virtual reality (“VR”) interface devices such as VR gloves and VR display helmets may be used. For output, preferable devices include computer display 212, for displaying objects such as text, graphics, animation, and video, and audio output devices for voice and sound clips. The audio and voice can be constructed from data snips stored as digitized sound files in libraries. AIternatively, voice can be synthesized from text. The invention is also adaptable to special output devices appropriate for particular purposes, and to new devices being developed.

Layer 222 in the multimedia user interface 201 comprises operating software and network communications. This software provides, among other services, support for I/O devices attached to the multimedia user interface 201, a file system with cache control, lower level network protocols, such as TCP/IP and ATM, and higher-level network protocols, such as HTTP. Basic EEL system capabilities are provided by executive software 223. The executive software verifies student identity and access authority, establishes communications sessions with the system servers as required during the session. Finally, the multimedia user interface 201 further includes standard components not shown, such as a microprocessor and input/output interfaces.

The EEL system further includes one or more server systems 205 of FIG. 2 with sufficient large capacity discs 230 for storing all student dynamic records 204 in the student database 214, all materials in the knowledge base 203, and the AI engine 202. In alternative embodiments, there can be more than one server with software and data component storage divided as convenient across the servers. In a preferred embodiment, the server can be a central host system. In comparison to the multimedia user interface 201, servers preferably have increased performance and higher speed network connections 231 in order to make this stored data quickly available to the one or more multimedia user interface 201.

The server systems are preferably configured as shown in FIG. 2 and are loaded with software providing the following function. First, there is operating system, network services, and file server layer 233. System manger 234 includes facilities for access control, authenticating student access requests and limiting file access to authorized users.

Alternative implementations of the functions described for the multimedia user interface systems and the server systems are also within the scope of this invention. For example, it is known to those of skill in the art that by the use of various technologies, such as remote procedure calls or messaging, the functions pictured here as grouped together and on one system can be divided and distributed if needed.

The server system of this invention performs multi-function: to execute software; to store databases of executable software elements, of student dynamic record, and of knowledge base. The latter two consist of heterogeneous and structured elements. These elements can be stored in a relational database such as supplied by the Oracle Corp. Microsoft, IBM, or the Sybase Corp.; they can be stored as specialized data files; or they can be stored in an object-oriented database system such as ObjectStore (Object Design Inc., Burlington, Mass.). The operating system of the server nodes must support whatever database systems are selected as well as network and application server software to access the databases.

The preferred server hardware and software can vary widely depending on the number of students to be simultaneously served. The number of servers and database distribution across a server cluster can be adjusted by means known in the art to satisfy projected peak loads. A suitable medium performance server system can be configured on a high end INTEL Pentium or DEC Alpha system with adequate memory and disk space. Windows.™ NT is an adequate server operating system, and Internet server software similar to that from Netscape is adequate for network access. The preferred database is an object oriented database such as ObjectStore. In this embodiment, application database access uses Java, XML, ASP, JSP; or a common gateway interface (“CGI”) program also providing database access and version control. The CGI access program can be implemented in C++, a suitable object oriented programming language capable of accessing interfaces to ObjectStore databases.

In a preferred embodiment, the primary means for authorizing and controlling access are passwords. System management of passwords preferably includes ensuring that user passwords are secure, not easily guessed, and are periodically changed. This invention is also adaptable to any other means of access control, including for example, passive and active identification cards and recognition of certain personal characteristics, such as voice. Access protection can be preferably provided by limiting access to system resources—database and file—based on a user's password. For example, access protection can be implemented in the CGI application access programs.

In a preferred embodiment, the communication between multimedia user interface and server by an Internet connection may be provided by the Java applets and servlets technique. Applets provide a convenient mechanism for building powerful, dynamic interfaces to applications, while servlets give us a highly efficient means to handle requests on a web or application server.

In another embodiment of the invention, the EEL system software can be located entirely in a single device, the hardware and software structure should be similar to the structure illustrated in FIG. 2 absent network related and redundant components. This system may be installed in a regular PC or a designated learning device.

5.2. EEL System Software and Database Structure

This section describes in detail functional structure for EEL software components. The structure described here is exemplary. This invention is adaptable to other structures with other allocation of the functions of this invention to different modules. Such alternative structures are easily designed by those of skill in the arts.

5.2.1. EEL System Software Structure

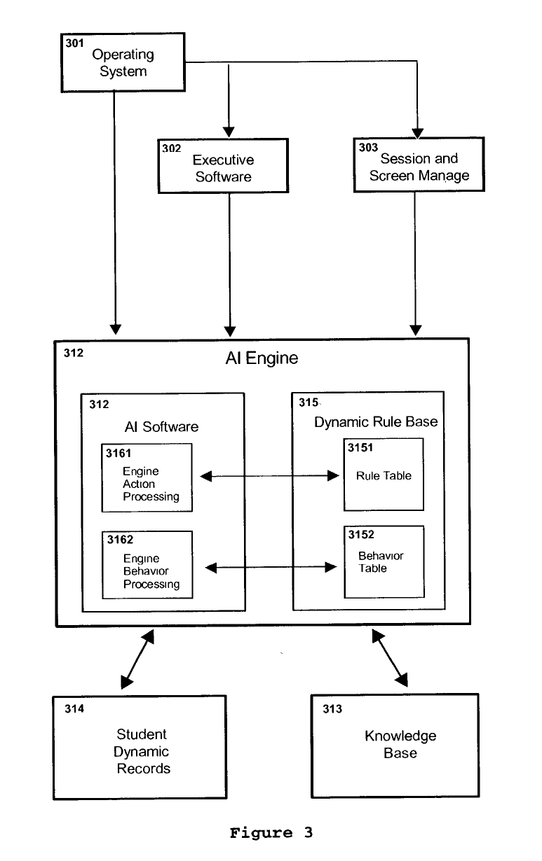

FIG. 3 illustrates the principal EEL system software and data components and the conceptual structure which reflects their interaction. An operating system 301 must be present, but this operating system 301 can be any available product known to those skilled in the art. At the next level is executive software 302 (“ES”). This software collects a number of components which customize the operating system to the requirements of this invention and also extend it, if needed. For example, all OS task creation is processed through an ES task control facility to insure that the student accesses only permitted materials. The ES software also provides a preferred animation facility and controls student startup.

In a preferred embodiment, session and screen manager 303 is present on an EEL system. The software can be permanently located in the multimedia user interface, or downloaded each time from the server. This component partitions the screen into the areas for the principal system components, and controls the system area. Thus, upon student selection of an icon presented in the system area it requests the ES to start the function represented. The system manager also presents whatever reward graphics and animation the student has been granted access. These functions are performed by calling the object level I/O facilities of the OS and ES.

Always present on an EEL system is student dynamic record 314. This record, preferably containing all the data in the EEL system relating to the student, is located in the server student database, and accessed when the student logs on to the system. Preferably, this record is divided into subtypes, and only those subtypes referenced are activated as required. AI engine 312 references and updates data items in the student dynamic record 314 according to the response from the student.

The learning materials are represented through session and screen manager 303 by AI engine 312 from knowledge base 313. Materials data is advantageously grouped into “entries” comprising the minimum items of presentation. Each entry is assigned with an entry number that can be identified by the AI engine in order to select the entry for display. Several levels of entry number can be assigned to particular entry in order to be used in sequencing logic. In one preferred embodiment, each entry is given a group number, possibly a subgroup number, and a sequence number. The entry can be divided into several execution steps, for example, material presenting step, explanation step, quiz step and feedback step. However, within the entry, the execution sequence will be fixed. In another preferred embodiment, each entry was a given only one entry number to present the content of the entry. As indicated below, this embodiment may provide more flexibility to adapt to individual learning needs.

AI engine 312 takes information from the student dynamic record 314 or from student's responses, and according to the rules in the rule base 315 selects the entries from knowledge base 313 and sends to multimedia user interface to be displayed by session and screen manager 303. Standard facilities of the OS and ES are used for entry presentation and for routing any input to the AI engine 312. Input is processed according to the entries presented referring to the rule base and with reference to the student dynamic record 314.

AI engine 312 determines display actions in response to the student's answer, which can also transforms display actions into displays of personae to the student. Engine action processing 3161 is rule based and event driven. Rules in rule table 3151 are evaluated using parameters both communicated in event messages from the materials or the student and retrieved from the student dynamic record. In a preferred embodiment, these rules propose candidate actions and then weigh and select a final set of engine actions from the candidates, which are communicated to subsequent engine behavior processing 3162. While engine processing also sets global variables for materials sequencing and control, in a preferred embodiment, these variables are only set as default instructions that can be overwritten by event input.

Engine behavior processing 3162 constructs an on-screen display based on the actions determined in engine action processing 3161. In a preferred embodiment, this processing is based on behavior tables 3152. Utterances, text or voice, and effects are selected from behavior tables 3152 based on the determined final actions and refined with parameters included with the actions. The utterances and actions are sent to the selected engine personae, which create the display of the selected personae using the utterances and effect selected. Data is referenced and updated in the student dynamic record 314 by this processing, in particular fields reflecting the student's personalization choices, such as the desired personae, and fields reflecting recent behaviors.

The rule table 3151 and behavior table 3152 compose the dynamic rule base 315. The dynamic rule base 315 can be updated by the AI engine 312 itself according to the learning outcome. Engine action processing 3161 and engine behavior processing 3162 are part of the engine AI engine software 316.

5.2.2. The Executive Software

The executive software (“ES”) collects together a number of components that customize the operating system to the requirements of this invention and, if needed, also extend it. ES software implements common and special facilities.

In a preferred embodiment, the executive software is loaded in the multimedia user interface. ES software may be built as front-ends, wrappers, or extensions to available OS software components. ES exemplary common facilities include task control, communications, and I/O facilities; the exemplary special facilities include an animation facility and a user logon and startup facility.

The task control facility manages the startup of system components. First, it verifies that the student is permitted to activate a requested component by checking limitations of the student based on student's data. Then, task control starts up the component by making any necessary OS calls. Task control also notifies other system components. The communication facility manages network communications and provides whatever client-server protocols are not present in the OS. Such protocols might include HTTP with URL name resolution. It maintains all necessary network sessions, including sessions with the knowledge base server, student dynamic record servers, AI engine servers, and executable software servers. In alternative implementations these servers can be on one or several physical server systems. Finally, this facility handles all remote access requests for information including requests for downloading and uploading. The I/O facilities contain input and output display handlers for interface display I/O. The display handlers receive object level requests for text, graphics, video and audio and translate them into whatever interface is supported by the OS.

Exemplary specialized ES facilities are animation and startup. It is preferable that the system support animation, which is a connected and timed sequence of displays potentially calling on all display modalities available, and other timed presentations. Although this invention is adaptable to any suitable animation facility, a preferred facility presents a script-based interface.

When the ES startup facility described herein runs on a network attached computer, the multimedia user interface setup of the EEL system can be downloaded from a server or a CD when needed, so no component of the system is resident on a multimedia user interface prior to startup. The initial step involves the student accessing any interface outlet attached to the EEL system. Preferably, accessing by a student user begins by accessing the server with the system manager, for example, using a standard intranet browser which can be resident on the interface outlet or downloaded by a power-on bootstrap process. The student logs on to the system manager, which then performs authentication, for example, by means such as password or identification card. Upon successful authentication, the system manager downloads and starts the ES. The ES then initiates necessary communication sessions, including those with the system servers, and then downloads the session manager software. The session manager presents the student display in a form depending on student preferences in the student dynamic record and receives input from the system area of the display.

5.2.3 AI engine

AI engine contains software and dynamic rule base. The AI engine software functions as a central processing component of the EEL system. The AI engine software receives input from the student sent from the multimedia user interface, and then calls on the student dynamic record, dynamic rule base, or knowledge base to process this information. The AI engine subsequently sends the output back to the multimedia user interface to be displayed to the student. The output from AI engine usually contains two parts. This first part is the response to the student's answer. The second part is the next learning material to be presented to the student.

AI engine determines both of these display actions in response to the student's answer, which can also transforms display actions into displays of personae to the student. Engine action processing is rule based and event driven. Rules in rules tables are evaluated using parameters both communicated in event messages from the materials or the student and retrieved form the student dynamic record. In a preferred embodiment, these rules propose candidate actions and then weigh and select a final set of engine actions from the candidates, which are communicated to subsequent engine behavior processing. While engine processing also sets global variables for materials sequencing and control, in a preferred embodiment, these variables are only set as default instructions that can be overwritten by event input.

Engine behavior processing constructs an on-screen display based on the actions determined in engine action processing. In a preferred embodiment, this processing is based on behavior tables. Utterances, text or voice, and affects are selected from tables based on the determined final actions and refined with parameters included with the actions. The utterances and actions are sent to the selected engine persona, which creates the display of the selected personae using the utterances and effect selected. Data is referenced and updated in the student dynamic record by this processing, in particular fields reflecting the student's personalization choices, such as the desired personae, and fields reflecting recent behaviors.

5.2.4 The Knowledge Base and Tools

This section describes a preferred embodiment for the knowledge base, and the student tools. In this embodiment, the knowledge base structure arranges material data that are used by the AI engine to appropriately generate displays and perform functions. In alternative embodiments, certain tools for example, can be separate programs that themselves maintain the necessary AI engine interface. Such certain tools include a calculator, a dictionary, an encyclopedia, and group communications.

5.2.4.1 The Knowledge Base

The material data in the knowledge base are grouped into entries, each entry representing a session of presentation. Each entry is assigned with an entry number that can be identified by the AI engine in order to select the entry for display. Several levels of entry number can be assigned to particular entry in order to be used in sequencing logic. In one preferred embodiment, each entry was given a group number, possibly a subgroup number, and a sequence number. The entry can be divided into several execution steps, for example, material presenting step, explanation step, quiz step and feedback. However, within the entry, the execution sequence will be fixed. In another preferred embodiment, each entry was a given only one entry number to present the content of the entry. As indicated below, this embodiment may provide more flexibility to adapt to individual learning need. In a preferred embodiment, each entry is set with different display mode. The AI engine will based on the student dynamic record to determine which display mode is going to be used; for example, the AI engine will decide whether to present a learning display, a complete review display, or a short review display.

5.2.4.2 The Tools

The general tools are preferably present in a range of forms selected according to data in the student dynamic record. One general tool is a calculator, which can have forms varying from a simple four-function calculator to a complex graphing calculator. Other general tools include language tools, such as a spelling checker, a thesaurus, a word pronouncer, an encyclopedia, and a dictionary. Another general tool is a word processor, perhaps with a drawing mode which can be provided as a multi-level set of writing and drawing tools. A last general tool is a link-maker, which offers exercises in various types of memorization, such as paired associates, serial learning, ordered serial learning, and mnemonics. Finally, additional tools can be added to an implementation to meet specific educational needs. For example for geography lessons a map tool can be added. For student projects, an encyclopedia tool and a network search tool can be added. Specialized tools can be added for commercial or industrial training.

5.2.5. Student Dynamic Record

One student dynamic record is created for each student in the EEL system and contains all the data concerning that student. The student data comprises fixed data defining the student as well as evolving data describing the student's interaction with the system, the latter including current and past performance, the dates of the performance and data defining the AI engine's view of the student in respect to the rule in the dynamic rule base. The student dynamic record is stored on the server system and is the source of the EEL system for interaction and setting of dynamic learning process. Elements of the student dynamic record are read by the AI engine as required once its associated student logs on to the system to determine the AI engine's action and provide learning materials to the student.

The student dynamic record is a record comprising structured student data in divided category related to certain time and certain identifying information for accessing and updating the student data. Student data is divided into global data, and materials related data, including tool related data. Global data, that is all items meaningful across all EEL materials, includes such subtypes as system data, behavior preference data, and student model data. System data includes student identifiers, student passwords, access privileges, etc. Student preferences can include options relating to visual appearance—species, gender, dress, or perhaps, no visual appearance—and similar options relating to audio behavior and text production.

The student dynamic record also includes one or more data updating methods and one or more data accessing methods. Exemplary updating method includes two components, triggering event type and action list. When the AI engine updates the student dynamic record, it sends a message to the object including an update event type and a list of relevant parameters. The updating methods are searched to find one with a triggering event type that matches the event type of the update event. The one or more methods having matching event types are then executed by performing all the actions in the included action list using the parameters in the update event message. Each action uses the supplied parameters to update data elements in the student dynamic record. The AI engine needing to determine the value of particular data element in the student dynamic record does so by sending an inquiry message to the student dynamic record requesting the desired data element. The inquiry method for that data element retrieves and then returns the desired value.

5.3. EEL System Operation

The structure of the interface among the AI engine, the knowledge base and the student dynamic record is important in the EEL system. It permits the AI engine to control a wide range of materials through which it guides each student. The AI engine achieves this by advantageously maintaining a dynamic rule base, which it references in diverse situations to determine its actions. This section, first, describes the general procedural structure of this interface, and second, describes the preferred model for the content of the interface. This preferred model is a progress tracking method (herein called “PTM”).

Communications between the AI engine and the knowledge base and AI engine and the student dynamic record are bi-directionals. Once a student logon to the system, his identification number is sent to the AI engine. The engine then reads the student dynamic records and finds a record with the matching identification number. This record is read by the AI engine, and will direct the engine to retrieve materials to be represented to the student. The student's response is sent to the AI engine to be evaluated according to the information retrieved from the knowledge base. The evaluation result will be recorded at the student's dynamic record, and the AI engine will base on the student response in respect with the information in the record, which represent the student's past performance, to decide what materials to be retrieved from the knowledge base.

5.3.1. The Progress Tracking Method

In order that the AI engine can act generally to provide student guidance and control material presentation in a manner individualized to the student's pedagogic characteristics, it is preferable that an embodiment of this invention uses a progress tracking method (herein called “PTM”). According to PTM, the student's past performance was evaluated and recorded. The evaluation of the performance is related to other information and previous performance, the result is preferably reflected as in certain stage of the progress. This record will later help to determine whether to review certain material, to give a quick test, or to start new materials, and what kind of new materials to be presented. The AI engine refers to rules adopted to provide the effective and efficient learning, according the psychological and educational theory. The rules also will be added or adjusted according to the learning outcome.

PTM is not limited to a particular set of educational paradigms. Any standard set or sets of paradigms appropriate to the intended students can be adopted for the interface standard. It is preferable that the standards adopted be based on principles of educational psychology and sound educational practice.

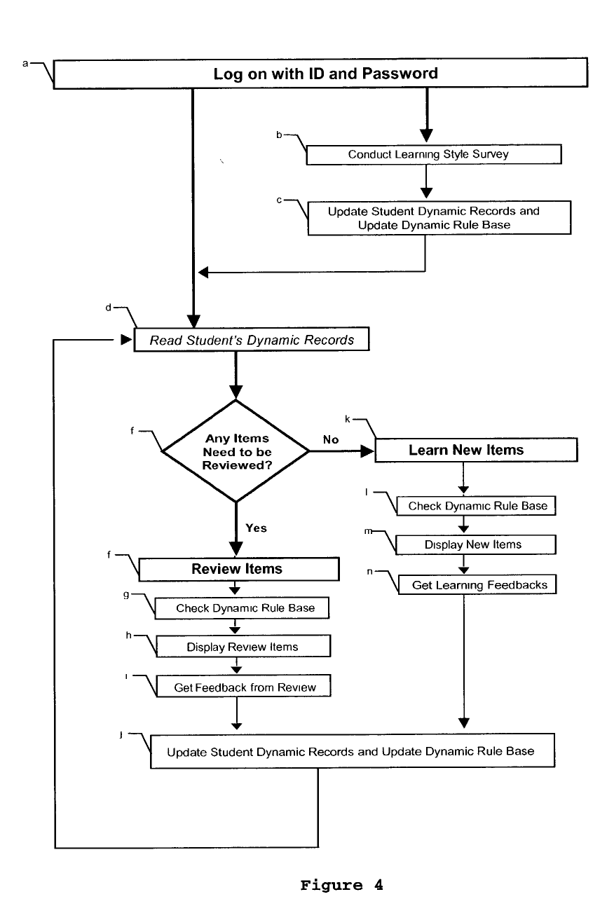

As shown in FIG. 4, the execution process of this method includes the following steps:

a. Logon with ID & Password, if the student is a new student go to step b, otherwise go to step d;

b. Conduct learning style survey;

c. Update student dynamic record and update dynamic rule base;

d. Read student dynamic record;

e. Check whether there are any items need to be reviewed, if yes go to step f;

otherwise, go to step k;

f. Review;

g. Check dynamic rule base;

h. Display review items;

i. Get feedback from review;

j. Update student dynamic record and update dynamic rule base, then go to step

k. Learn a new item;

l. Check dynamic rule base;

m. Display a new item;

n. Get learning feedback and go to step j.

5.3.2 AI Engine Adaptivity

The adaptation of the AI engine to the student, emerges first from the EEL's updating of data in the student dynamic record. In the preferred embodiment, the system's knowledge of the student is represented by data in the student dynamic record, which stores performance data specific to particular assigned materials and courses. As the student interacts with the system for instruction or homework, the system receives the responses, which describe the student's learning and performance. The AI engine updates the student dynamic record with data from these responses. As these data are updated, the engine adapts to the student, and thereby it individualizes to the student. This adaptation is maintained across sessions with this student. This adaptation is achieved through the interaction of AI engine with student dynamic record. Only student dynamic record is individualized, AI engine has universal function and this one and only AI engine can deal with each individual separately.

In the preferred embodiment, the data referenced and updated by the AI engine are specially organized according to date of the performance, the type of the performance and the level of the performance. Thus, the record reflects the process of the student's progress and the student's current status. This record organization scheme is the advantage of this invention. This method will allow the EEL system to provide individualized curriculum for each student and provide review schedules to help the student obtain long-term memory.

In the preferred embodiment, the engine adaptivity will also include responses to student's personality and learning goal. In this embodiment, the student's psychological data, emotional data and learning preference can be recorded in general data record along with student's performance record. This information can be obtained in difference manner. The system can conduct a survey in the initial logon of each student. The AI engine will take these general data into account in addition to student's dynamic record in selecting alternative learning curriculum. For example, in the same level of study, different style of materials, different sequence of material arrangement maybe available for student with different personality and learning goal. In addition, the student's emotion in current session maybe recorded in temporary file that can be referred into through the current session for the AI engine to make decisions.

The AI engine's determination of any actions in relation to the student dynamic record and the current response can be rule based or otherwise. The specific model for AI engine's rule structure maybe according to the educational or psychological theories. One detailed embodiment is illustrated below.

5.3.3 Exemplary Illustration of the Current Invention

The current exemplary embodiment of this invention is an Automatic Review System (ARS). Forgetfulness is the biggest enemy of learning. This embodiment specifically targets this problem. In this embodiment, the education theory utilized is the method of review. It is based on the notion that the review method indicated below is an efficient and effective way of memorizing the materials. It also brings the understanding of individual differentiation into software design. It can be used to assist student to remember word, grammar, or any other materials in a given area.

In this embodiment, for example, the student will be given words to learn. The student can choose to stop at any time. For each word, they can click the front token of sample sentence to listen to it or click an icon to have a short cartoon movie related to that word. They can also click any word on the screen to know its pronunciation. Furthermore, they can double click any word to have whole information of that word. After the information related to the word is displayed, the system will automatically display a quick test. If the student answers the test correctly, a student dynamic record will be created for this word.

At this time, the record will reflect the identification number of this word; the review level (RL), which is one at this time, and the date the review level is set. If the student does not answer the test correctly, the system may provide additional information, review the display, or ask student if he wants to skip the word. The system may divide the words into different level of difficulties that are reflected in the assigned entry number in the knowledge base. When the student answers a word incorrectly, or has difficulties with this word, the system can choose the next word that is less difficult.

The reviewing process occurs when the student logs on to the system the next time. After the system check the student's identification number, and permit access, this number will be used by AI engine to find the matching student dynamic record. Words with review date earlier or equal to the logon date will be reviewed first. If the student passes the test for the review, the AI engine will update the student dynamic record by update the review level to the next level, and the date that set this review level. The review date is obtained by the AI engine by adding the date that set the review level and the number of days for the next review represented by this review level. Following is the referring table:

| | | | | | | | | | | | | |
|---|---|---|---|---|---|---|---|---|---|---|---|---|
| RL | 1 | 2 | 3 | 4 | 5 | 6 | 7 | 8 | 9 | 10 | 11 | 12 |
| Days | 1 | 1 | 2 | 3 | 5 | 8 | 13 | 21 | 34 | 55 | 89 | 134 |

According to this table, the word just been learned will be reviewed more frequently. However, if the student cannot past the review test, the AI engine will update the date that set the review level in the student's dynamic record, and the review level will be reduced by one. Therefore, if the student cannot remember this word, this word will be reviewed more frequently because the student is still at the low review level. Only if the student is able to past the test every time will the system stop to review this word eventually. At this point, according to the psychological and educational theory, the student is less likely to forget the word. The system can automatically adjust the rule of the review level according to the learning outcome, or it can provide the student to change the review level of that word to generate next review time if the student so chooses.

This system can be installed in a single hand held device, or to be built in a car. The multimedia user interface may be provided with sound control, for the convenience of the user. As mention above, this system can be used for materials other than words. The same concept would apply.

Specific Embodiments, Citation of References

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. Various publications are cited herein, the disclosures of which are incorporated by reference in their entireties.

What is claimed is:

1. A method of operating an effective and efficient learning system for interactive instruction of one or more students, said method comprising:
checking identification numbers of said students and accessing respective dynamic records of said students through an AI engine;
accessing to one or more knowledge base and selecting materials according to said dynamic records of said students through said AI engine and presenting said materials to said student; and
comparing responses from said students with information at said knowledge base and updating respective dynamic records of said students wherein said dynamic records of said students contain date recorded.

2. The method of claim 1, wherein said effective and efficient learning system utilizes one or more multimedia user interface.

3. A method of operating an effective and efficient learning system for interactive instruction of one or more students, said method comprising:
checking identification numbers of said students and accessing respective dynamic record of said students through an AI engine;
reviewing materials according to said dynamic record of said student through said AI engine from one or more knowledge base;
comparing responses from said students with information at said knowledge bases and updating respective dynamic records of said students;
accessing to said knowledge bases and selecting materials according to said dynamic records of said students through said AI engine and presenting said materials to said student; and
comparing responses from said students with information at said knowledge base and creating new dynamic records of said students.

4. The method of claim 3, wherein said effective and efficient learning system utilizes one or more multimedia user interface.

5. The method of claim 4, wherein said system is stored in one or more computers, said computers are interconnected with each other and multimedia user interface by a network.

6. The method of claim 4, wherein said dynamic record for each said students comprises:
one or more item recording numbers; and
performance evaluation record.

7. The method of claim 5, wherein said dynamic record further comprises recorded date.

8. The method of claim 4, wherein said knowledge base comprises entries comprising of one or more steps of displaying materials, whereby said entries are assigned with respective entry number.

9. The method of claim 7, wherein said entries have different display modes.

10. The method of claim 8, wherein said display modes comprise learning display mode;
complete review mode, and
short review mode.

11. The method of claim 4, wherein said AI engine comprises software and rule base.

12. The method of claim 9, wherein said rule base may be modified.

13. The method of claim 7, wherein said materials are comprising of text, graphics, speech, audio, animation, video, and preformatted animated sequences.

14. The method of claim 4, further comprises a step of providing guiding information.

15. The method of claim 12, wherein said guiding information is displayed with one or more personae.

16. The method of claim 4, wherein said knowledge base comprises words, and definitions.

17. The method of claim 15, wherein said multimedia user interface comprises sound recognition device.
